(19) United States
(12) Patent Application Publication
(10) Pub. No.: US 2003/0137969 A1
(43) Pub. Date: Jul. 24, 2003

(54) Time synchronisation for mobile systems

(76) Inventors: Ouelid Abdesselem, Toulouse (FR); Steven Brandt, Round Lake, IL (US); Christopher Bussan, Crystal Lake, IL (US)

Correspondence Address: MOTOROLA INC, 600 NORTH US HIGHWAY 45, LIBERTYVILLE, IL, 60048-5343, US

(21) Appl. No.: 10/297,680

(22) PCT Filed: Jun. 8, 2001
(86) PCT No.: PCT/EP01/06628

(30) Foreign Application Priority Data
Jun. 9, 2000 (EP) 00401642.4

(51) Int. Cl. H04J 3/06

(52) U.S. Cl. 370/350

(57) ABSTRACT

A method of maintaining time synchronisation of a mobile terminal, of a telecommunications network, said mobile terminal having high speed and low speed clocks, in a deep sleep mode, comprising: when a deep sleep mode is entered, making an initial measurement to establish a frequency relationship between the high speed and low speed clocks, entering a deep sleep mode in which the high speed clock is deactuated, and updating said correlation based on the time of arrival of paging blocks, timed by the low speed clock.

### BACKGROUND ART

This invention relates to time synchronisation for mobile systems. In particular, but not exclusively, it relates to a method for synchronising a mobile terminal such as a mobile telephone, particularly a GSM telephone, with a network and maintaining this synchronisation when the mobile terminal is in a deep sleep mode.

A GSM terminal typically has two clock sources. These are a high speed clock source at 13 MHz, and a 32 KHz crystal. The high speed 13 MHz clock source is used during normal use of the terminal and also when the terminal is in communication with a base station. The lowest current drain state the terminal can enter (other than being powered off) is known as deep sleep. In deep sleep, the terminal can conserve power by turning off its hardware block of components and also by turning off the crystal that generates the high speed 13 MHz clock (CLK_REF) and by not driving any devices that use the CLK_REF. When deep sleep state is entered, power is removed from the CLK_REF source. The low speed clock (CLK_{—}32 KHz) is used to keep track of time during the period that CLK_REF is shut down.

The software in a GSM type system is layer based. The bottom layer, layer 1, relates to initial signal processing, and mapping on signal channels, etc. The use of CLK_{—}32 KHz allows layer 1 of the GSM type system to maintain synchronisation with a network. It also allows a timer to be set up to bring the phone out of deep sleep for layer 1 events and other events. This timer keeps track of time while in deep sleep mode using CLK_{—}32 KHz. It is therefore important that CLK_{—}32 KHz be kept in synchronisation.

Before entering deep sleep, a measurement is done to establish the frequency relationship between CLK_{—}32 KHz and CLK_REF. This allows time kept by CLK_{—}32 KHz to be converted into CLK_REF time so that the phone can stay synchronised to the network. This measurement has to be done since the relationship between CLK_{—}32 KHz and CLK_REF is constantly changing due to say crystal drift, jitter and ramping of CLK_{—}32 KHz. CLK_REF is a reference frequency; its frequency is intermittently adjusted to match the frequency of network transmissions and therefore CLK_REF remains essentially stable.

One problem with the measurement method is the duration of time that the measurement must be performed over to get an accurate relationship between the two clocks, that is, the time of the 32 KHz clock which is required to obtain a number of periods of the CLK_REF. The amount of time required for the measurement to get an accurate relationship between the clocks is much greater than the actual time the system needs to be awake to read paging blocks, for example, from the network. At least a 500 ms measurement duration (often typically around 800 ms) is required to obtain the necessary accuracy to wake up and read a paging block. However, spending 500 ms taking a measurement would generally consume too much current.

In a present method of working around this problem, in addition to reading the paging block, another Signallying Channel (SCH) burst is read first, which can tolerate more timing error. SCH is a specialised signalling channel, the functioning of which is well known to those skilled in the art. The use of this technique allows the measurement time to be reduced to about 40 milliseconds. However, the necessity of waking up early to read the SCH burst and the power consumed reading the burst also adversely affects overall current drain.

The present invention arose in an attempt to provide an improved time synchronisation method with reduced power consumption.

### DISCLOSURE OF THE INVENTION

According to the present invention in a first aspect there is provided a method of maintaining time synchronisation of a mobile terminal, of a telecommunications system, said mobile terminal having a low speed clock and a high speed clock, wherein the low speed clock is at least partly maintained in synchronisation with a clock of a remote station by measuring the time of arrival of signal bursts from said remote station.

According to the present invention in a second aspect there is provided a method of maintaining time synchronisation of a mobile terminal, having high speed and low speed clocks, in a deep sleep mode, comprising; making an initial measurement to establish a frequency relationship between the high speed and low speed clocks, entering deep sleep mode, waking the terminal and measuring timing correlation peak offsets between a network high speed clock and the low speed clock of the mobile terminal, and using the correlation peak offset values to correct for frequency drift of the low speed clock.

Preferably, the method includes attributing a portion of the correlation peak offset to the frequency drift of the low speed clock, averaging this to the time drift offset, and deriving a correction value to correct full frequency drift.

The initial measurement can be over a relatively long period to establish a correlation between the high speed and low speed clocks.

Alternatively, an initial measurement may be made by the low speed clock, independently of the high speed clock, by measuring time of arrival of sychronisation channel bursts (eg SCH bursts in GSM system), by the remote station.

In embodiments of the present invention, an initial, long, measurement is taken to establish a frequency correlation between the mobile terminal's high speed and low speed clocks. This correlation is updated based on the time of arrival of network bursts (ie paging blocks), related to the clock of the base station or other external terminal. The timing difference between bursts received before sleeping and after sleeping is used to update the high speed to low speed clock frequency correlation. The update is preferably achieved by instantaneously averaging a fraction of the timing difference into the frequency correlation.

Accordingly, using methods according to the present invention, network timing is used to determine the drift of a mobile terminal's low speed clock while the mobile terminal was in a sleep mode during a paging block period.

Preferably, if a terminal wakes up and is then unable to decode a paging block for any reason, it falls back to reading the signal channel SCH. If it can decode the SCH, then cell timing can be updated and the next attempt at reading the paging block is more likely to be successful.

Advantageously, if the SCH cannot be decoded, then the mobile terminal continues trying to read subsequent SCH and paging blocks. If paging block decode errors become too numerous, then it is considered that the mobile terminal has lost use of a cell, and the process of acquiring a cell begins again. The process of acquiring cells and channels is well known. Before entering deep sleep mode in a newly acquired cell, a method according to the present invention will begin again from the start by taking a new long measurement. The present invention further provides a mobile terminal, of a telecommunications network, the terminal comprising a high speed clock and a low speed clock, and means for maintaining the low speed clock in synchronisation by measuring and utilising the time of arrival of signal bursts from an external station.

### BRIEF DESCRIPTION OF THE DRAWINGS

Embodiments of the invention will now be described, by way of example only, with reference to the accompanying drawings in which:

FIG. 1 shows a mobile terminal in radio communication with a base station;

FIG. 2 shows clock pulses from a low speed clock and a high speed clock within a mobile terminal;

FIG. 3 shows a series of paging bursts; and

FIG. 4 shows a scenario of paging bursts.

### DETAILED DESCRIPTION OF PREFERRED EMBODIMENTS

Referring to FIG. 1, a telecommunications Network N comprises a plurality of mobile terminals (e.g. cellular phones), of which one is shown at 1. The mobile terminal includes processing circuitry 2 and a high speed clock, CLK_REF 3 which operates at 13 MHz. The terminal also includes a deep sleep module 4 which incorporates a low speed clock 5, CLK_{—}32 KHz

In a cellular system, a base station 7 lies at the heart of each cell and communicates with each mobile terminal in known manner so that data can be transmitted and received by the mobile terminal in a known manner. This can be voice communication, data communication, video communication, signalling information or any other transmission etc. The base station includes processing means 8 and a clock 9. When the mobile terminal 1 is in active communication with the base station 7, then the high speed clock 3 is used for timing purposes and this is locked to the network (or at least the base station from which the terminal receives data. The base station transmits many types of signals, including synchronisation channels SCH, paging channels PCH, and others.

In GSM, PCH is a paging channel sent by the base station at predetermined time slots in order to initiate a mobile—terminal call or data transfer. SCH is a Synchronisation CHannel broadcast by the Base Station allowing initial accurate sychronization of the Mobile Stations on the corresponding cell. It contains the frame number and multiframe number for that particular cell. The SCH burst includes a wider midamble (64 bits) than a normal burst e.g. PCH burst (26 bits), allowing the Mobile Station to catch the burst even if it was not fully sychronized (typically a Mobile station catches an SCH burst shifted by up to +/−20 bits, while it can catch up a normal burst shifted only by +/−5 bits). So SCH has been defined by GSM standard bodies for initial synchronization on serving cell and neighbouring cells.

SCH and PCH are specific to GSM, and perhaps other systems, but most wireless communication systems utilise similar concepts of paging channels and syncronization channels. The present invention is applicable also to these.

The lowest current drain state a terminal can enter (other than being powered off) is known as deep sleep. While in deep sleep mode, a GSM phone switches off the high speed clock source and uses the low speed clock source CLK_{—}32 KHz 5 in order to greatly reduce power consumption. The 32 KHz crystal is free running and is not locked to the system that the phone receives data from. Use of CLK_{—}32 KHz allows layer 1 to maintain synchronisation with the network. It also allows the timer to be set up to bring the phone out of deep sleep for layer 1 events and EXEC events.

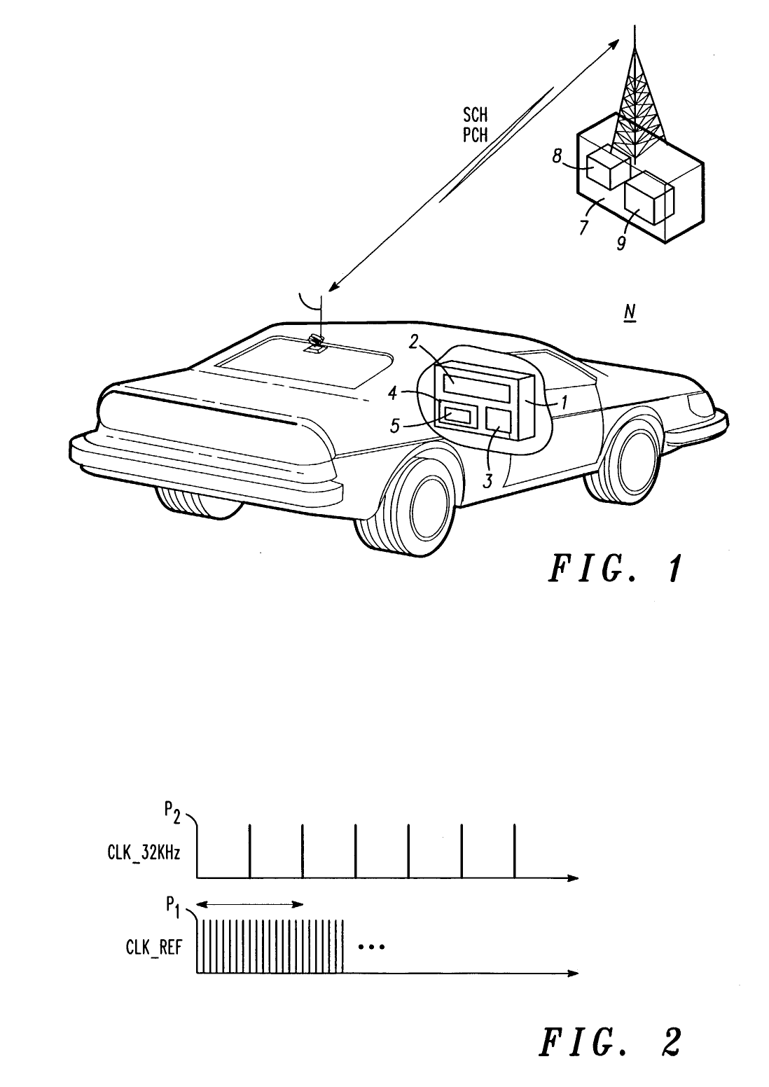

Before entering deep sleep mode, an initial measurement is done to establish a frequency relationship between CLK_{—}32 KHz and CLK_REF. As shown in FIG. 2, this may comprise measuring the number of cycles P1 of the 13 MHz clock in a predetermined number of cycles P2 of the 32 KHz clock. The diagram is schematic. In practice, there will be many more cycles of CLK_REF in each cycle of CLK_{—}32 KHz than shown. The time required for this, to get enough accuracy, will depend upon circumstances and technology. It will generally take at least 500 ms. This is dependent upon, for example, jitter, ramp up/ramp down sharpness, sensitivity to temperature drifts and other considerations.

In prior art methods, the 13 MHz crystal is adjusted by means of the received signal. This is done by frequency or phase rotation comparisons between the expected received bursts and actual received bursts. The drift of the 32 KHz clock is then measured by computing a period ratio between the two clocks in the mobile terminal, using some hardware logic.

In the present invention, an initial measurement is taken, as described in relation to FIG. 2, for establishing an initial frequency relationship between CLK_{—}32 KHz and CLK_REF. This provides a seed for a time drift offset. The mobile telephone 1 then enters a deep sleep mode which will be termed ‘idle’ mode. When the phone wakes up, paging bursts (PCH) are read from the base station 7. This enables a timing correlation peak offset to be computed between the base station and the mobile terminal. This may be done by measuring the time of arrival of the paging blocks (otherwise known as network bursts). The timing difference between bursts received before sleeping and after sleeping is then used to update the CLK_REF to CLK_{—}32 KHz frequency correlation. This update is preferably done by instantaneously averaging a fraction of the timing difference into the frequency correlation. Accordingly, timing derived from the network (or base station) itself is used to determine the drift of CLK_{—}32 KHz while the terminal sleeps during a paging block period.

Features of the invention will now be described in more detail.

In embodiments of the present invention, the drift of the low speed clock of the mobile terminal is measured based upon the high speed clock (13 MHz clock) 9 of the base station, by means of time of arrival of PCH blocks, after the mobile terminal's low speed clock had already been accurately tuned by initial measurements.

After the mobile terminal has performed an initial measurement to obtain drift of the 32 KHz against its internal 13 MHz clock (e.g. during a time period of about 500 to 800 ms, typically 600 ms), then the terminal enters an idle mode. In this mode, the mobile terminal runs its low speed clock during DRX periods and its high speed clock during active periods only. The drift of the low speed clock is measured using the time of arrival of the signalling blocks (paging blocks) from the base station.

In GSM, DRX is Discontinuous Reception Mode. The DRX period is well known in GSM and other telephone systems and one DRX period is a multiframe, which is typically 235 ms. A paging block (PCH) is typically of around 20 ms. The DRX_period is equal to the number of multiframes between paging blocks. So DRX2=2×multiframes, DRX9=9 multiframes, etc.

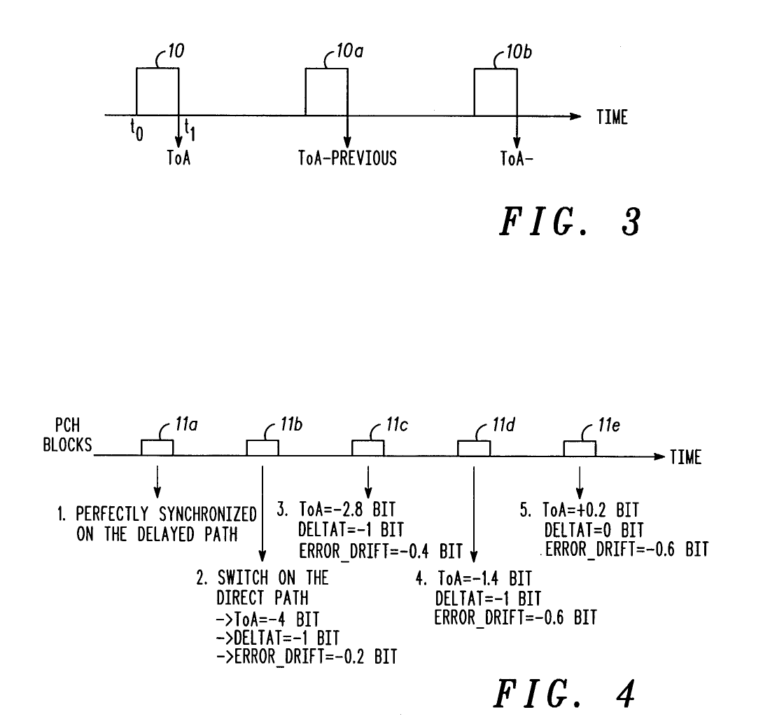

Referring now to FIG. 3, there are shown (schematically) bursts of a PCH block from a base station. In fact, each block 10 shows the average of four block bursts. Conventionally in GSM systems, four bursts are sent in a paging block. If the average time when a PCH block is transmitted is T₀ then the average time at which the full bursts are received (time of arrival—ToA is T₁). Blocks 10a and 10b show subsequent blocks of four bursts. These will then be continued. The average time of arrival of each of the bursts is determined by using the 32 KHz clock since the system is now in the locked mode.

If synchronisation is perfect, then the ToA value would be kept to 0. However, the ToA may vary due to many reasons, including

variation in the multipath profile from one block to another

error of estimation in the processor

drift of the 32 KHz clock or mobility of the mobile terminal.

By averaging the ToA's, then the last effect (drift of the 32 KHz clock or mobility of the mobile terminal) becomes predominant. Hence, it is preferred (but not essential) to average a plurality of bursts. The average time of arrival of each of the groups of four bursts (e.g. group 10b) is compared with the average time of arrival of the last group of four bursts (e.g. group 10a). Thus ToA_Current is compared with ToA_Previous in the Figure.

A suitable formula is then used to correct the drift of the 32 KHz clock. This formula may take many forms, as will be apparent to the skilled reader. One (non-limiting) example is described below.

When the next group of bursts is received, their time of arrival is compared with the time of arrival of the previous group and the drift can then again be corrected. This continues whilst the mobile terminal is in idle mode.

One formula for correcting the drift of the 32 KHz clock is:

Drift_{—}32=1/alpha*deltaT/T_{—}32(deltaT and T_{—}32 are both in quarter bit).

With alpha=5*(DRX_period/2 seconds)

T_{—}32 is the time spent by the 32 KHz clock between the subsequent ToA's.

DeltaT is equal to ToA but clipped inside a range of quarter bits of typically −4 to +4. DeltaT is also used to correct the layer 1 timer counters.

If T_{—}32 is less than the DRX_period/2, then the measurement is discarded.

So, for DRX 9, alpha=5 and for DRX2, alpha=22.

The coefficient alpha is used to take into account only part (i.e. a fraction) of the timing difference into the frequency correlation.

Knowing that the drift_coefficient is the fractional ratio which provides the number of 13 MHz periods for a given number of 32 KHz periods, then,

drift_coefficient=drift_coefficient×(1-drift_{—}32)

The deep sleep mode can now be handed with an updated drift coefficient and the drift of the 32 KHz clock is substantially allowed for.

With previous techniques, extra SCH bursts had to be added. These unnecessary SCH bursts can now be removed. As soon as the SCH is removed, whatever the accuracy of the 32 KHz clock, there is a much higher constraint on the total timing error (including multipath, mobility, clock drifts, clipping and rounding errors, and hardware uncertainties); the received signal generally needs to be kept in-between [−5, +5] bits between two paging blocks.

The time checking algorithm has to keep synchronisation by means of paging blocks. This means that firstly the time adjustment is done after each serving cell signalling block (clipping of +/−1 bit) and secondly the signal from the base station is kept in the range [−5, +5] bits.

Whatever the algorithm chosen to estimate the 32 KHz, and it must be remembered that the algorithm described above is only one of several which can be used, then errors (in bits) may appear due to;

[−4, +4] in case of severe multipath profiles (e.g. hilly terrain)

[−0.6, +0.6] for clock drift and mobility

[−0.3, +0.3] for rounding errors

[−0.3, +0.3] as a provision for jitter in hardware when switching from/to the 32 KHz clock.

It is found that some eleven correlations are being performed by the signal processor of the mobile terminal. This is therefore capable of acquiring the [+4, −4] bit switches described above, with an additional one bit margin on each side. This is much less than from an SCH burst, so it is important to have an accurate algorithm to estimate the ToA values.

It is firstly important to define the burst position in a signalling block, the time of arrival of which is measured. After having performed correlations, the position of the maximum correlation peak is obtained. In one embodiment of the invention, the middle of the energy window is defined as being the position of the burst in a signalling block. In other embodiments, a different measurement may be made. However, by using the middle of the energy window, as soon as more than one path is detected (e.g. direct and delayed paths) then the mobile terminal can synchronise in-between them. This leads to a more stable time base. It also reduces rounding error, typically from +/−0.5 to +/−0.3 bits.

An additional feature is the choice of averaging a plurality of individual ToA's to get the overall ToA of a signalling block. As described, in a preferred embodiment, four individual ToA's are averaged. However, more or less than these may be averaged. Such averaging is better in fast fading cases than the time tracking by means of one SCH burst. The averaging computation can then still be enhanced compared to current methods by taking into account signal to noise ratio or any other quality indicator for each individual burst. In one example

ToA=sum(SNRi*ToAi)/sum[SNRi] for i=1,4

The ToA values may first be clipped (deltaT) before applying time correction (by +/−one bit instead of +/−0.5 bits for SCH in current layer 1), ensuring smooth update of the mobile terminal's time base.

The deltaT values may be further filtered before being considered for the 32 KHz drift estimation, ensuring smooth update of the 32 KHz drift coefficient (limited to less than one quarter bit per block of current).

If a mobile terminal is unable to decode a paging block, of if there is Downlink Signalling Failure, then it can revert to trying to read subsequent SCH blocks. This may happen, for example, with extreme multipath cases if the blocks go beyond the normal window in which they are expected, or with extreme temperature variations which may lead the 32 KHz clock to drift too quickly. For DRX9, this drift would have to be greater than 0.2 ppm per second.

The definition of Downlink Signalling Failure is specified by GSM.

If the SCH decodes on such an attempt, then the cell timing can be updated and the next attempt at reading the paging block is more likely to be successful. Alternatively, if the SCH does not decode, then the mobile terminal continues trying to read SCH and paging blocks. If paging block decode errors become too numerous, then the cell is considered to be lost and the process of acquiring a cell has to begin again. Before entering deep sleep mode on a newly acquired cell, the process has to begin from the start by taking a new long measurement to determine the relationship between CLK_REF and CLK_{—}32 KHz.

In one embodiment, +/−0.6 bits are allowed for drift inaccuracy estimation and mobility errors of the 32 KHz clock. The algorithm which is used to estimate the drift from the ToA's should preferably keep these errors in the range +/−0.6 bits.

One problem arises with mobility of a mobile terminal. If a terminal is moving away from or towards the base station, then there will be some effect on clock frequency and of course the doppler effect comes into play. At a radial speed of 250 km per hour, which is +/−0.15 quarter bits each two seconds, then the mobility will appear as a 32 KHz drift. This will then be automatically corrected in embodiments of the invention.

The following Table 1 indicates tuning of the averaging parameter for a worst case of DRX9.

TABLE 1

| | Maximum crystal drift that | Accuracy of the 32 |
|---|---|---|
| alpha | can be corrected | KHz estimation |
| 3 | +/− 18 ppm per minute | +/− 1 bit |
| 5 | +/− 12 ppm per minute | +/− 0.6 bit |
| 10 | +/− 6 ppm per minute | +/− 0.3 bit |
| (alpha = 10, DRX4) | (+/− 25 ppm per minute) | (+/− 0.3 bit) |

The maximum crystal drift than can be corrected is deducted from (1/alpha)*(deltaT=3.69us)/(T_{—}32=2s). That value is multiplied by (60s/T_{—}32=2s) to provided the drift per minute. If the temperature variations are sometimes higher than these, then a recovery mechanism using SCH decoding can be attempted.

Concerning the accuracy of the 32 KHz estimation, a worst case has been considered, i.e.

hilly terrain profile, with delayed paths of −4 bits,

2 extreme scenarios; scenario 1 for which the mobile terminal was synchronised on the direct path and suddenly switches to the delayed path, and scenario 2 for which the contrary occurs.

FIG. 4 shows schematically a scenario in which, between blocks 11a and 11b, the terminal switches between the delayed path and the direct path. The Figure shows that if the mobile terminal is able to correctly receive block 11_{b} (ToA of −4 bits) then it recovers the time base three blocks later and the error on the 32 KHz clock drift estimation is kept at a low value (−0.6 bit). That error drift comes back quickly to 0 (for example −0.4 bit on the 7^{th} block, −0.2 bits on the 9^{th} block and so on).

In embodiments of the invention, an initial measurement is taken for the drift of the 32 KHz clock against the mobile terminal's 13 MHz clock. Various methods may be used for these. In one method, by means of a hardware deep sleep module, an initial measurement of approximately one second can be made, which is sufficient to obtain two quarter bits accuracy.

In a second alternative, a set of a plurality of SCH's (in one embodiment ten) may be used to average the estimated initial 32 KHz drift.

The choice of these or other methods may depend upon power consumption and other considerations which will be apparent to the skilled reader. The first option is likely to consume approximately 30 mW is current GSM radios, assuming that the layer 1 timer is not running. Otherwise, it will be approximately 50 mW. The second option is likely to involve a power consumption of approximately 10×2 mW=20 mW.

However, option 1 may be optimised so that the time taken is 500 ms instead of 1 second, running the measurements while in a select mode (and thus the two methods may be quite close in terms of power consumption).

In embodiments of the invention, unnecessary FCH and SCH windows are removed. It has been estimated that standby time improvements of up to 28% or more, compared to presently available designs, may be achieved.

In the embodiments described above, CLK_{—}32 KHz is initially synchronised with CLK_ref by measuring the number of cycles of CLK_ref in a predetermined number of cycles of CLK_{—}32 KHz. Alternatively, the two clocks may be completely independent. This may be achieved by initially using CLK_{—}32 KHz to measure ToA's of SCH bursts. This then initially synchronises CLK_{—}32 KHz before Deep Sleep Mode. The 32 KHz clock should be sufficiently accurate to catch the SCH bursts (130 ppm).

1. A method of maintaining time synchronisation of a mobile terminal, of a telecommunications network, said mobile terminal having a low speed clock and a high speed clock; wherein the low speed clock is at least partly maintained in synchronisation with a clock of a remote station by utilising the time of arrival of signal bursts from said remote station.

2. A method as claimed in claim 1, comprising; making an initial measurement to establish initial synchronisation between the low speed clock and the network, entering a deep sleep mode and using the time of arrival of paging blocks from a remote station in the network, measured by the low speed clock, to correct frequency drift of the low speed clock.

3. A method as claimed in claim 1, comprising; making an initial measurement to establish a frequency relationship between the high speed and low speed clocks of the mobile terminal, entering a deep sleep mode and updating said relationship based upon the time of arrival of paging blocks from a remote station in the network, measured by the low speed clock, to correct frequency drift of the low speed clock.

4. A method as claimed in claim 3 wherein the initial measurement comprises measuring the number of cycles of the high speed clock of the mobile terminal in a predetermined number of cycles of the low speed clock.

5. A method as claimed in claim 1, wherein the times of arrival of paging blocks are used to measure timing correlation peak offsets between a network high speed clock and the low speed clock of the mobile terminal, and wherein the correlation peak offset values are used to correct the frequency drift of the low speed clock.

6. A method as claimed in claim 5, wherein a portion of the correlation peak offset is attributed to the frequency drift of the low speed clock, the method further comprising averaging this portion to a time drift offset, and deriving a correction value to correct full frequency drifts.

7. A method as claimed in claim 5, comprising using timing differences between network bursts to update the correlation between the low speed and high speed clocks of the terminal, by instantaneously averaging a fraction of the timing difference into the frequency correlation.

8. A method as claimed in preceding claim, wherein an initial measurement is done over a period of at least 500 ms, to establish initial synchronisation of the low speed clock.

9. A method as claimed in preceding claim, wherein, in a mobile telephone system, if a mobile terminal is unable to decode a paging block for timing correlation, it utilises a secondary recovery mechanism.

10. A method as claimed in any preceding claim, wherein, in a mobile telephone system, if Downlink signal failure is detected, a secondary recovery mechanism is used.

11. A method as claimed in claim 9 or claim 10, wherein the recovery mechanism comprises reading an SCH and, if the terminal is able to decode the SCH, updating the timing of the low speed clock.

12. A method as claimed in claim 11, wherein if the SCH is not able to be decoded, the mobile telephone instigates a process for reacquiring a cell and initiates a further initial measurement to establish a relationship between its high speed and low speed clocks.

13. A method as claimed in any of claims 2 to 10, wherein the overall time of arrival of a signalling burst is derived by averaging a plurality of individual time of arrivals.

14. A method as claimed in claim 13, wherein an average is taken of four bursts.

15. A method as claimed in any of claims 2 to 14, wherein the time of arrival values are clipped before applying a time correction to them.

16. A method as claimed in any preceding claim, wherein the terminal is a mobile terminal of a cellular telephone system, the low speed clock has a nominal rate of 32 KHz and the high speed clock has a nominal rate of 13 MHz.

17. A method of maintaining time synchronisation of a mobile terminal, having high speed and low speed clocks, in a deep sleep mode, comprising; making an initial measurement to establish a frequency relationship between the high speed and low speed clocks, entering deep sleep mode, waking the terminal and measuring timing correlation peak offsets between a network high speed clock and the low speed clock of the mobile terminal, and using the correlation peak offset values to correct for frequency drift of the low speed clock.

18. A mobile terminal, of a telecommunications network, the terminal comprising a high speed clock and a low speed clock, and means for maintaining the low speed clock in synchronisation by measuring and utilising the time of arrival of signal bursts from an external station.

19. A mobile terminal as claimed in claim 18 including means for measuring the times of arrival of paging blocks from said external station, and means for using the times of arrival to correct frequency drift of the low speed clock.

20. A method of maintaining time synchronisation of a mobile terminal, substantially as hereinbefore described with reference to, and as illustrated by, the accompanying drawings.

21. A mobile terminal substantially as a method of maintaining time synchronisation of a mobile terminal, substantially as hereinbefore described with reference to, and as illustrated by, the accompanying drawings
